(19) United States
(12) Patent Application Publication
(10) Pub. No.: US 2026/0001019 A1
(43) Pub. Date: Jan. 1, 2026

(54) IN-LINE SEPARATOR

(71) Applicant: Stephen Arthur McDaniel, Winston Salem, NC (US)

(72) Inventor: Stephen Arthur McDaniel, Winston Salem, NC (US)

(21) Appl. No.: 18/758,799

(22) Filed: Jun. 28, 2024

(51) Int. Cl. B01D 45/08

(52) U.S. Cl. CPC B01D 45/08

(57) ABSTRACT

An in-line separator for reducing sparks from grinding, welding, cutting, and other industrial applications. The in-line separator provides spark reduction, reduces damage to filter media, has minimal pressure drop, zero footprint, easy installation, and operates in a vertical or horizontal position. The in-line separator removes filter media and other elements in airflow by using cyclonic motion to cause the filter media and other airflow elements to drop out of the airflow.

### BACKGROUND

Industrial debris filtration and collection systems include in-line separators for removing material (e.g., dust) from an airstream. Typically, the in-line separator removes material before an end collection container. Current industrial debris filtration and collection systems include filter media bags at an end of the industrial debris filtration and collection system that captures dust and similar elements. These bags must be replaced over time because current industrial debris filtration and collection systems fail to effectively remove debris from an airstream prior to the filter media bags.

### FIELD OF THE INVENTION

The present invention is generally related to in-line separators, more specifically to in-line separators with improved cyclonic action.

### BRIEF SUMMARY OF THE INVENTION

In some embodiments, an in-line separator for removing dust and similar waste particles from air is disclosed. The in-line separator includes an inlet, an inlet tapered portion, a tapered airflow diverter component, a body portion, an outlet tapered portion, and an outlet. The inlet is in fluid communication with an inlet tapered portion. The body portion is in fluid communication with the inlet tapered portion and the outlet tapered portion. The tapered airflow diverter component is positioned within an interior of the inlet tapered portion. When air passes through the inlet to the inlet tapered portion, the tapered airflow diverter component diverts the airflow into a body of portion of the in-line separator. After entering the body portion of the in-line separator, the velocity of the airflow decreases, allowing for dust and other waste particles to fall out of the airstream.

In some embodiments, the in-line separator further includes a drop out. The drop out is connected to a bottom of the body portion. In some embodiments, the drop out includes a top end connected to the body portion and a bottom end connected to a storage container. In some embodiments, a diameter of the first end of the drop out is larger than a diameter of the bottom end of the drop out.

In some embodiments, the tapered airflow diverter component does not include vanes. This is particularly advantageous for stringy material.

In some embodiments, the in-line separator further includes an outlet duct positioned within the outlet and the outlet tapered portion. In some embodiments, the circumference of the outlet duct is greater than a circumference of a bottom of the tapered airflow diverter component.

In some embodiments, a circumference of the inlet tapered portion is equivalent to a circumference of the outlet tapered portion.

In some embodiments, the in-line separator includes a cleanout window. The cleanout window is positioned on an exterior surface of the body portion. The cleanout window is movable between an open position and a closed position. When in the open position, the cleanout window provides access to the interior of the body portion.

In some embodiments, the outlet is directly connected to the tapered airflow diverter component via a plurality of rods. In some embodiments, the plurality of rods is welded to the outlet duct and the tapered airflow diverter component.

In some embodiments, the tapered airflow diverter component results in airflow passing to a top of an interior of the body portion and a bottom of an interior of the body portion.

In some embodiments, the inlet is in fluid communication with a downstream dust collector.

In some embodiments, the in-line separator uses centrifugal force to remove particles from the air. Dust-laden air is received in the in-line separator from an upstream dust collector. Once the dust-laden air is in the in-line separator, the dust-laden air undergoes cyclonic motion and loses velocity. As a result of the cyclonic motion and decreased velocity, dust falls out of the air to a bottom of the in-line separator because the dust particles cannot stay in the airstream. Advantageously, this reduces the burden on filter media bags that can be used downstream from the in-line separator.

In some embodiments, the in-line separator maintains an airflow velocity between about 3,000 feet per minute and about 3,500 feet per minute resulting in a pressure loss of about 2″ inches of water column. In some embodiments, the in-line separator receives airflow at about 3500 feet per minute. In some embodiments, the in-line separator receives airflow between about 3500 feet per minute and about 4000 feet per minute. In some embodiments, the in-line separator is designed to reduce an inlet airstream velocity to about 1500 feet per minute when the inlet airstream enters a body portion of the in-line separator.

In some embodiments, an industrial debris filtration and collection system is disclosed. The industrial debris filtration and collection system includes a debris collector, an in-line separator, a negative pressure generation component, and a downstream container. The debris collector is operable to capture dust and similar particles. The negative pressure generation component creates airflow from the debris collector to the in-line separator. The in-line separator includes an inlet, a tapered inlet portion, a tapered airflow diverter component, a body portion, a tapered outlet portion, an outlet, and a drop out. The inlet is connected to the inlet tapered portion and the outlet tapered portion. The body portion is connected to the inlet tapered portion and the outlet tapered portion. The tapered airflow diverter component is positioned within an interior of the inlet tapered portion. When air passes through the inlet to the inlet tapered portion, the airflow diverter component diverts the airflow into the body portion of the in-line separator. The velocity of the airflow is reduced when traveling through the body portion of the in-line separator. The tapered airflow diverter component is connected to the outlet.

In some embodiments, the drop out includes a top end connected to the body portion and a bottom end connected to a storage container. In some embodiments, a diameter of the first end of the drop out is larger than a diameter of the bottom end of the drop out.

In some embodiments, the tapered airflow diverter component does not include vanes.

In some embodiments, the in-line separator further comprises a cleanout window. The cleanout window is positioned on an exterior surface of the body portion. The cleanout window is movable between an open position and a closed position. When in the open position, the cleanout window provides access to an interior of the body portion.

In some embodiments, the outlet is connected to the tapered airflow diverter component via a plurality of rod extensions.

In some embodiments, the in-line separator includes a body portion with a volume of about three times a volume of an inlet duct. The inlet duct has the same volume as an outlet duct. The difference in volume decreases the velocity of airflow, allowing material to fall out of the airflow and into a drop out.

### BRIEF DESCRIPTION OF THE DRAWINGS

The embodiments illustrated, described, and discussed herein are illustrative of the present invention. As these embodiments of the present invention are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

FIG. 1 illustrates an in-line separator according to one embodiment of the present invention.

FIG. 2 illustrates an in-line separator according to one embodiment of the present invention.

FIG. 3 illustrates an in-line separator including a drop out according to one embodiment of the present invention.

FIG. 4 illustrates an in-line separator including a drop out according to one embodiment of the present invention.

FIG. 5 illustrates an in-line separator including a drop out according to one embodiment of the present invention.

FIG. 6 illustrates an airflow diverter component according to one embodiment of the present invention.

FIG. 7 illustrates a front view of an in-line separator according to one embodiment of the present invention.

### DETAILED DESCRIPTION

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a,” “an,” and “the” refer to “one or more” when used in the subject specification, including the claims. Thus, for example, reference to “a device” can include a plurality of such devices, and so forth.

Unless otherwise indicated, all numbers expressing quantities of components, conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

Industrial facilities need in-line separators to improve the filtration and collection of dust and similar particles from grinding, welding, and cutting applications to protect workers and dust collection systems. In some embodiments, the present invention includes an in-line separator improving the collection and filtration of dust and similar waste materials from grinding, welding, cutting, and other industrial applications. The in-line separator reduces damage to filter media, has minimal pressure drop, zero footprint, easy installation, and operates in a vertical or horizontal position. Advantageously, the in-line separator eliminates the need for a secondary dust accumulation point.

In some embodiments, using negative pressure, airflow is passed to an in-line separator (e.g., from a debris collector) and undergoes cyclonic motion that results in the airflow losing velocity. As a result, large particles fall out of the airflow, thereby reducing the need for filter media bags at an end of an industrial filtration and collection system.

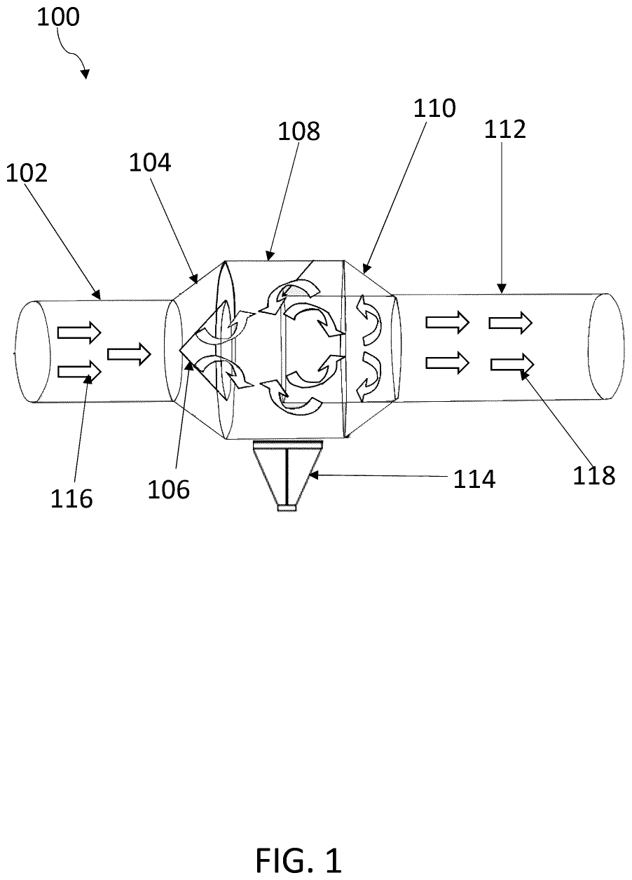

FIG. 1 illustrates an in-line separator according to one embodiment of the present invention. The in-line separator 100 includes an inlet 102, an inlet tapered portion 104, a tapered airflow diverter component 106, a body portion 108, an outlet tapered portion 110, an outlet 112, and a drop out 114. Airflow passes through the inlet 102 to the inlet tapered portion 104 as shown by arrows 116. For example, and not limitation, the in-line separator 100 is connected to a dust collector. Once the airflow passes into the inlet tapered portion 104, the airflow is interrupted by the tapered airflow diverted component 106. In some embodiments, the tapered airflow diverter component does not include vanes. The airflow is diverted into a top of an interior of the body portion 108 and a bottom of the interior of the body portion 108. The airflow undergoes cyclonic motion while traveling through the body portion. The airflow is further redirected off of the interior walls of the body portion 108 and an interior surface of the tapered airflow diverter component 106. The airflow proceeds throughout the outlet tapered portion 110 and the outlet 112 as shown by arrows 118. In some embodiments, the tapered airflow diverter component 106 is connected to the outlet tapered portion 110 and/or the outlet 112. For example, and without limitation, the in-line separator includes a plurality of rods connecting the tapered airflow diverter component and the outlet 112.

As a result of the cyclonic motion, dust and similar materials can collect at a bottom of the body portion. The drop out 114 receives the collected elements and passes the materials to a sealed container. Advantageously, this eliminates the need for filter media bags at an end of the in-line separator for the collection of dust and similar materials. In some embodiments, the drop out includes a tapered shape. In some embodiments, the drop out includes a curved shape, a rectangular shape, and other polygonal shapes. The drop out includes a top end connected to a bottom of the body portion and a bottom end connected to a sealed container. In some embodiments, the circumference of the top end of the drop out is larger than the bottom end of the drop out.

In some embodiments, a circumference of the outlet 112 is larger than a circumference of the inlet 102. In some other embodiments, the circumference of the inlet 102 is larger than a circumference of the tapered airflow diverter component 106. In some other embodiments, a circumference of the outlet 112 is smaller than a circumference of the tapered airflow diverter component 106.

In some embodiments, the outlet 112 is directly connected to the tapered airflow diverter component. In some other embodiments, the outlet 112 is not connected to the tapered airflow diverter component. In some embodiments, the in-line separator supports an airflow velocity of about 3200 feet per minute (FPM) with a pressure drop of about 0.8 inches. In some embodiments, the in-line separator is operable to receive an airflow between about 3500 FPM to about 4000 FPM. In some embodiments, a velocity of the airflow reduces to about 1300 FPM when traveling through the body portion.

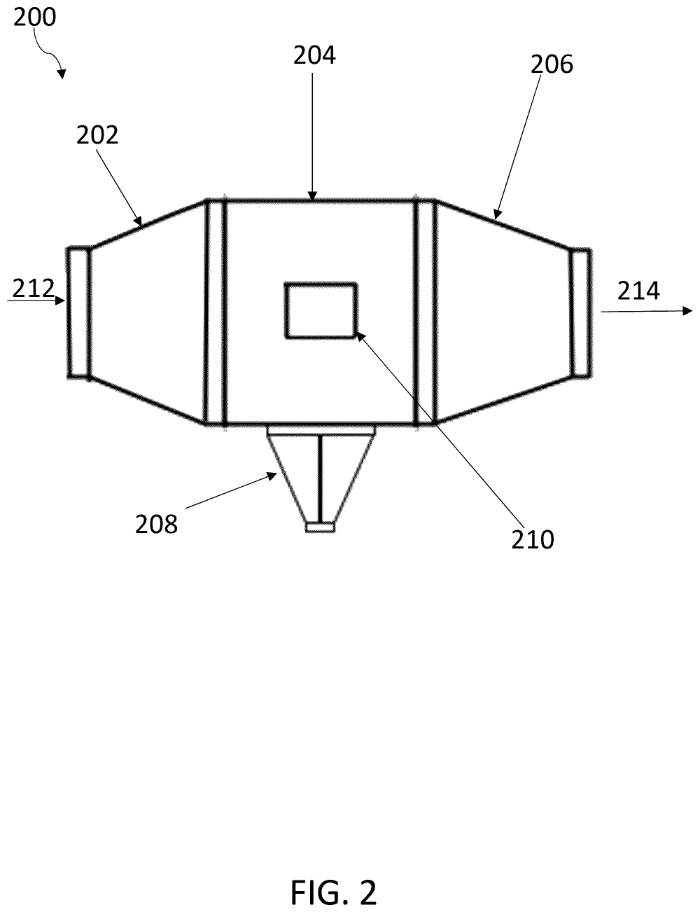

FIG. 2 illustrates a side view of an in-line separator including a drop out according to one embodiment of the present invention. The in-line separator 200 includes a tapered inlet 202, an airflow diverter component (not shown), a body portion 204, a tapered outlet 206, a drop out 208, and a cleanout window 210. The in-line separator 200 receives air containing dust from an upstream debris collector or similar machine and/or system. Once the airflow passes into the tapered inlet 202 as shown by arrow 212, the airflow is interrupted by the airflow diverter component. The airflow diverter component is positioned in an interior of the in-line separator. For example, and not limitation, the airflow diverter component is positioned within the tapered inlet. In some embodiments, the airflow diverter component does not include vanes. The airflow is diverted by the airflow diverter component into a top of an interior of the body portion 204 and a bottom of the interior of the body portion 204. The airflow is further redirected off of the interior walls of the body portion 204 and an interior surface of the airflow diverter component. The airflow proceeds throughout the tapered outlet 206 and downstream to a collection system as shown by arrow 214.

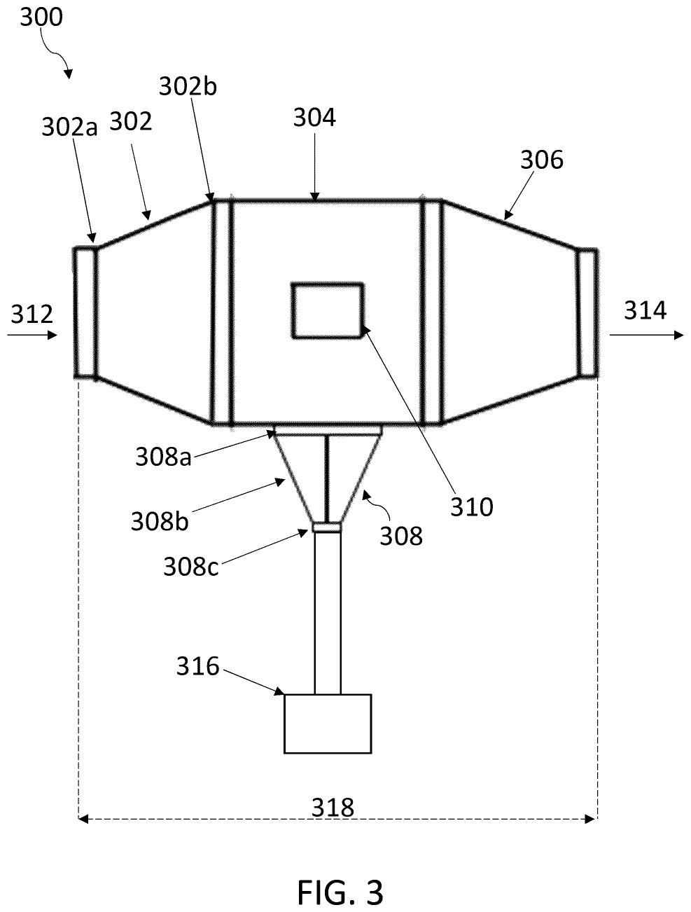

When in the body portion of the in-line separator, the airflow undergoes cyclonic motion. As a result, dust and similar materials can collect at a bottom of the body portion. The drop out 208 receives the collected elements and passes the materials to a sealed container. Advantageously, this eliminates the need for filter media bags at an end of the in-line separator for the collection of dust and similar materials. In some embodiments, the drop out includes a tapered shape. As shown in FIG. 3, the drop out includes a top end connected to a bottom of the body portion and a bottom end connected to a sealed container 316. In some embodiments, a circumference of the top end of the drop out is larger than a circumference of the bottom end of the drop out.

In some embodiments, the cleanout window 210 is operable to move between an open position and a closed position. When in the open position, the cleanout window 210 enables access to the interior of the in-line separator for cleaning and inspection purposes. In some embodiments, the cleanout window includes a gasket positioned around a perimeter of an interior of the window. In some embodiments, the cleanout is connected to the body portion of the drop out via an attachment mechanism. For example, and not limitation, the attachment mechanism includes a plurality of latches and/or a plurality of hinges.

In some embodiments, the in-line separator includes a plurality of attachment mechanisms for connecting each piece. For example, and not limitation, the in-line separator includes a plurality of clamp joints. In some embodiments, a clamp joint is positioned between the tapered inlet and the body portion, and a second clamp joint is positioned between the tapered outlet and the body. In some embodiments, the in-line separator is a unitary piece.

In some embodiments, the in-line separator is designed for an airflow between about 3000 feet per minute and 3500 feet per minute and a pressure drop of about 0.8 inches. Advantageously, the in-line separator is operable to capture between about 85% to about 95% of dust and similar materials in the airflow.

FIG. 3 illustrates a side view of an in-line separator including a drop out according to one embodiment of the present invention. The in-line separator 300 includes a tapered inlet 302, an airflow diverter component (not shown), a body portion 304, a tapered outlet 306, a drop out 308, and a cleanout window 310. The in-line separator 300 receives air containing dust from a debris collector or similar machine and/or system. Once the airflow passes into the tapered inlet 302 as shown by arrow 312, the airflow is interrupted by the airflow diverter component. The airflow diverter component is positioned in an interior of the in-line separator 300. For example, and not limitation, the airflow diverter component is positioned within the tapered inlet. In some embodiments, the airflow diverter component does not include vanes. The airflow is diverted into a top of an interior of the body portion 304 and a bottom of the interior of the body portion 304. The airflow is further redirected off of the interior walls of the body portion 304 and an interior surface of the airflow diverter component. The airflow proceeds throughout the tapered outlet 306 and downstream to a collection system as shown by arrow 314.

When in the body portion of the in-line separator, the airflow undergoes cyclonic motion. As a result, dust and similar materials can collect at a bottom of the body portion. The drop out 308 receives the collected elements and passes the materials to a sealed container 316. Advantageously, this eliminates the need for filter media bags at an end of the in-line separator for the collection of dust and similar materials. In some embodiments, the drop out includes a tapered shape. In some embodiments, a circumference of the top end of the drop out is larger than a circumference of the bottom end of the drop out.

In some embodiments, the in-line separator has the following dimensions:

| Tapered | Tapered | | | | | |
|---|---|---|---|---|---|---|
| Inlet | Inlet | | Top of | Body of | Bottom of | Cleanout |
| Diameter | Diameter | Length | Drop out | Drop out | Drop out | Window |
| (in.) 302a | (in.) 302b | (in.) 318 | (in.) 308a | (in.) 308b | (in.) 308c | (in.) 310 |
| 4 | 8 | 36 | 4 | 8 | 4 | 6 × 8 |
| 5 | 9 | 40 | 5 | 8 | 4 | 6 × 8 |
| 6 | 11 | 45 | 6 | 8 | 4 | 8 × 10 |
| 7 | 12 | 41 | 7 | 8 | 4 | 8 × 10 |
| 8 | 14 | 46 | 8 | 8 | 4 | 8 × 10 |
| 9 | 16 | 48 | 9 | 8 | 4 | 8 × 10 |
| 10 | 18 | 51 | 10 | 8 | 4 | 8 × 10 |
| 12 | 22 | 59 | 12 | 8 | 4 | 10 × 12 |
| 14 | 25 | 66 | 14 | 14 | 6 | 10 × 12 |
| 16 | 29 | 70 | 16 | 14 | 6 | 10 × 12 |
| 18 | 33 | 78 | 18 | 14 | 6 | 12 × 14 |
| 20 | 36 | 81 | 20 | 14 | 6 | 12 × 14 |
| 22 | 40 | 85 | 22 | 14 | 6 | 12 × 14 |
| 24 | 44 | 96 | 24 | 14 | 6 | 12 × 14 |
| 26 | 46 | 102 | 24 | 18 | 6 | 12 × 14 |
| 28 | 50 | 110 | 24 | 18 | 6 | 12 × 14 |
| 30 | 54 | 114 | 24 | 18 | 6 | 12 × 14 |
| 32 | 58 | 121 | 24 | 18 | 6 | 12 × 14 |
| 34 | 62 | 131 | 24 | 18 | 6 | 12 × 14 |
| 36 | 66 | 137 | 24 | 18 | 6 | 12 × 14 |
| 38 | 70 | 155 | 24 | 18 | 6 | 12 × 14 |
| 40 | 72 | 159 | 24 | 18 | 6 | 12 × 14 |
| 42 | 76 | 163 | 24 | 18 | 6 | 12 × 14 |
| 44 | 80 | 167 | 24 | 18 | 6 | 12 × 14 |
| 46 | 84 | 184 | 24 | 18 | 6 | 12 × 14 |
| 48 | 88 | 188 | 24 | 18 | 6 | 12 × 14 |

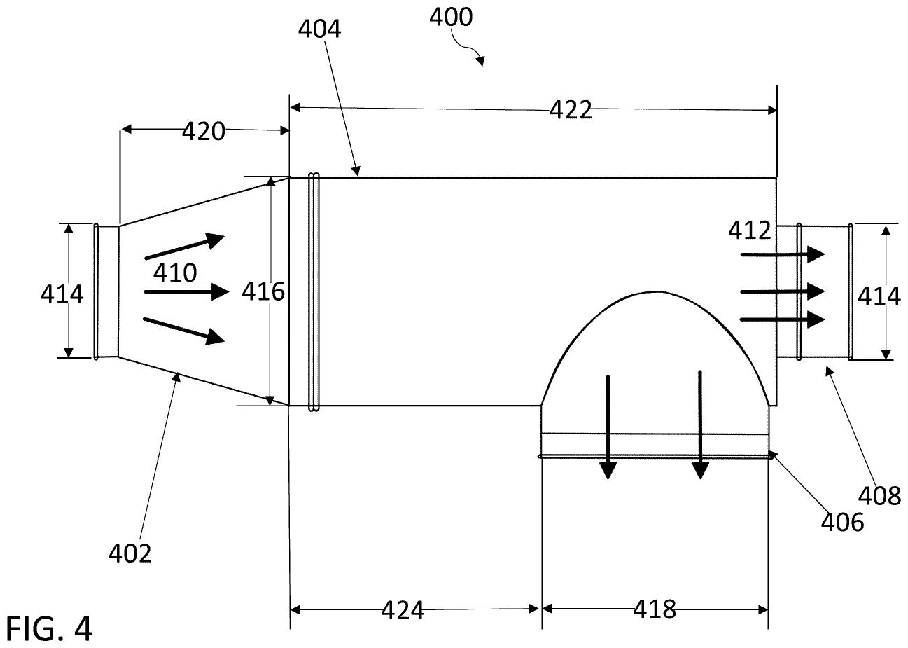

FIG. 4 shows an in-line separator according to at least one embodiment of the present invention. For example, and without limitation, the in-line separator 400 includes a tapered inlet 402, an air diverter component (not shown), a body 404, a drop out 406, and an outlet 408. The in-line separator receives air containing dust from a debris collector or similar machine and/or system. Once the airflow passes into the tapered inlet 402 as shown by arrow 410, the airflow is interrupted by the airflow diverter component. The airflow diverter component is positioned in an interior of the in-line separator. For example, and without limitation, the airflow diverter component is positioned within the tapered inlet. In some embodiments, the airflow diverter component does not include vanes. The airflow is diverted into the interior of the body portion 404 and undergoes cyclonic motion. As a result of the cyclonic motion, the airflow loses velocity before proceeding downstream to a collection system as shown by arrow 412.

As a result of the cyclonic motion and decreased velocity, dust and similar materials can collect at a bottom of the body portion. The drop out 406 receives the collected elements and passes the materials to a sealed container. Advantageously, this eliminates the need for filter media bags at an end of the in-line separator for the collection of dust and similar materials. In some embodiments, the drop out includes a tapered shape.

In some embodiments, the in-line separator receives an airflow inlet of about 3500 feet per minute. In some embodiments, the airflow is between about 3500 feet per minute and about 4000 feet per minute. In some embodiments, the air diverter component includes a conical shape and a plurality of fins. In some embodiments, the plurality of fins includes a 25-degree angle. Each fin is positioned approximately 90 degrees relative to another fin. In some embodiments, the plurality of fins includes a quarter-rounded shape. Advantageously, the in-line separator is operable to capture between about 85% to about 95% of dust and similar materials in the airflow.

In some embodiments, the in-line separator includes the following dimensions:

| Tapered | Tapered | | Length of | | Length of | |
|---|---|---|---|---|---|---|
| Inlet | Inlet | | Tapered | Length of | In-line | Drop Out |
| Diameter | Diameter | Drop out | Inlet (in.) | Body (in.) | separator | Offset (in.) |
| (in.) 414 | (in.) 416 | (in.) 418 | 420 | 422 | (in.) | 424 |
| 6 | 11 | 11 | 10.4 | 23 | 33.4 | 10.5 |
| 7 | 12 | 12 | 13.6 | 25 | 38.6 | 11.5 |
| 8 | 14 | 14 | 13.6 | 29 | 42.6 | 13.5 |
| 9 | 16 | 16 | 15.2 | 33 | 48.2 | 15.5 |
| 10 | 18 | 18 | 16.8 | 37 | 53.8 | 17.5 |
| 11 | 19 | 19 | 16.8 | 39 | 55.8 | 18.5 |
| 12 | 22 | 22 | 20 | 45 | 65 | 21.5 |
| 13 | 22 | 22 | 20 | 45 | 65 | 21.5 |
| 14 | 25 | 24 | 20 | 49 | 69 | 24.5 |
| 15 | 26 | 24 | 21.6 | 50 | 71.6 | 25.5 |
| 16 | 28 | 24 | 23.2 | 52 | 75.2 | 27.5 |
| 17 | 30 | 24 | 24.8 | 54 | 78.8 | 29.5 |
| 18 | 32 | 24 | 26.4 | 56 | 82.4 | 31.5 |
| 19 | 33 | 24 | 26.4 | 57 | 83.4 | 32.5 |
| 20 | 35 | 24 | 26.4 | 59 | 85.4 | 34.5 |
| 22 | 39 | 24 | 29.6 | 63 | 92.6 | 38.5 |
| 24 | 42 | 24 | 32.8 | 66 | 98.8 | 41.5 |
| 26 | 46 | 24 | 36 | 70 | 106 | 45.5 |

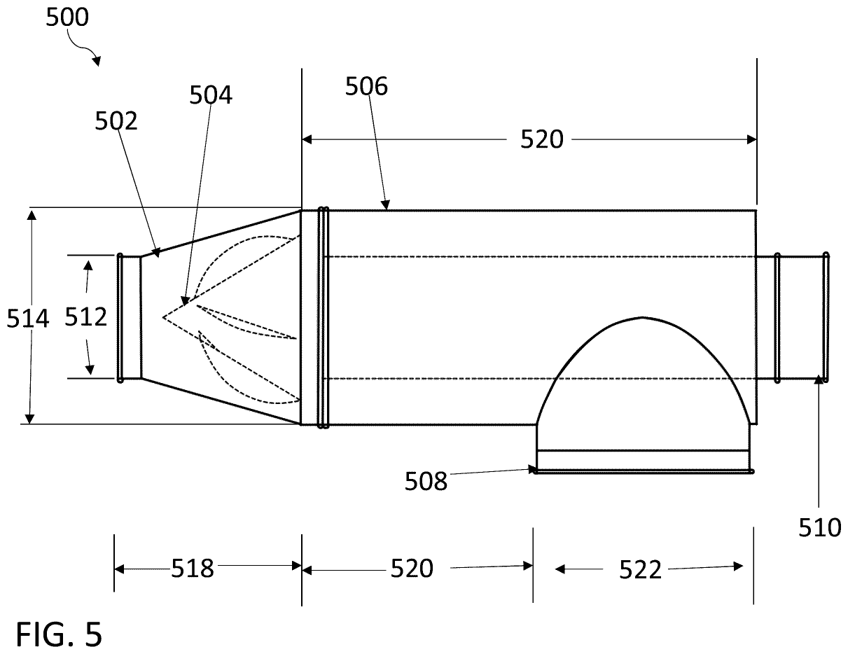

FIG. 5 shows an in-line separator according to at least one embodiment of the present invention. For example, and without limitation, the in-line separator 500 includes a tapered inlet 502, an air diverter component 504, a body 506, a drop out 508, and an outlet 510. The in-line separator 500 receives air containing dust from a debris collector or similar machine and/or system. Once the airflow passes into the tapered inlet 502, the airflow is interrupted by the airflow diverter component 504. The airflow diverter component 504 is positioned in an interior of the in-line separator 500. For example, and without limitation, the airflow diverter component is positioned within the tapered inlet. In some embodiments, the airflow diverter component does not include vanes. In some embodiments, the airflow diverter component includes a plurality of fins. Each fin of the plurality of fins is at an angled position relative to a central line of the airflow diverter component. For further example, and without limitation, the plurality of fins is at about a 25-degree angle relative to a central line of the airflow diverter component. In some embodiments, each fin of the plurality of fins is positioned about ninety degrees or a quarter of the circumference of the airflow diverter component. In some embodiments, the airflow diverter component includes carbon steel.

After entering the body portion of the in-line separator, the airflow undergoes cyclonic motion before proceeding downstream to a collection system. As a result of the cyclonic motion, the velocity of the airflow decreases, and dust and similar materials fall out of the airflow. For example, and without limitation, the velocity of the airflow decreases to about 1300 feet per minute. The dust and similar materials can collect at a bottom of the body portion. The drop out 508 receives the collected elements and passes the materials to a sealed container. Advantageously, this eliminates the need for filter media bags at an end of the in-line separator for the collection of dust and similar materials. In some embodiments, the drop out includes a tapered shape.

In some embodiments, the in-line separator receives an airflow inlet of about 3500 feet per minute. In some embodiments, the airflow is between about 3500 feet per minute and about 4000 feet per minute. Advantageously, the in-line separator is operable to capture between about 85% to about 95% of dust and similar materials in the airflow.

For example, and without limitation, in some embodiments, the in-line separator has the following dimensions:

| | | Tapered | | Drop | | | |
|---|---|---|---|---|---|---|---|
| Tapered | | Inlet | Body End | out | Tapered | Body | |
| Inlet | Reducer & | Diameter | plate | Length | Inlet | Length | Drop Out |
| Diameter | Outer Body | (in.) | Thickness | (in.) | Length | (in.) | Offset |
| (in.) 512 | Thickness | 514 | (in.) | 516 | (in.) 518 | 520 | (in.) 522 |
| 6 | 16 Ga. | 11 | 10 Ga | 11 | 10.4 | 23 | 10.5 |
| 7 | 16 Ga. | 12 | 10 Ga | 12 | 13.6 | 25 | 11.5 |
| 8 | 16 Ga. | 14 | 10 Ga | 14 | 13.6 | 29 | 13.5 |
| 9 | 16 Ga. | 16 | 10 Ga | 16 | 15.2 | 33 | 15.5 |
| 10 | 16 Ga. | 18 | 10 Ga | 18 | 16.8 | 37 | 17.5 |
| 11 | 16 Ga. | 19 | 10 Ga | 19 | 16.8 | 39 | 18.5 |
| 12 | 16 Ga. | 22 | 10 Ga | 22 | 20 | 45 | 21.5 |
| 13 | 16 Ga. | 22 | 10 Ga | 22 | 20 | 45 | 21.5 |
| 14 | 16 Ga. | 25 | 10 Ga | 24 | 20 | 49 | 24.5 |
| 15 | 16 Ga. | 26 | 10 Ga | 24 | 21.6 | 50 | 25.5 |
| 16 | 16 Ga. | 28 | 10 Ga | 24 | 23.2 | 52 | 27.5 |
| 17 | 14 Ga. | 30 | 3/16 | 24 | 24.8 | 54 | 29.5 |
| 18 | 14 Ga. | 32 | 3/16 | 24 | 26.4 | 56 | 31.5 |
| 19 | 14 Ga. | 33 | 3/16 | 24 | 26.4 | 57 | 32.5 |
| 20 | 14 Ga. | 35 | 3/16 | 24 | 26.4 | 59 | 34.5 |
| 22 | 14 Ga. | 39 | 3/16 | 24 | 29.6 | 63 | 38.5 |
| 24 | 14 Ga. | 42 | 3/16 | 24 | 32.8 | 66 | 41.5 |
| 26 | 14 Ga. | 46 | 3/16 | 24 | 36 | 70 | 45.5 |

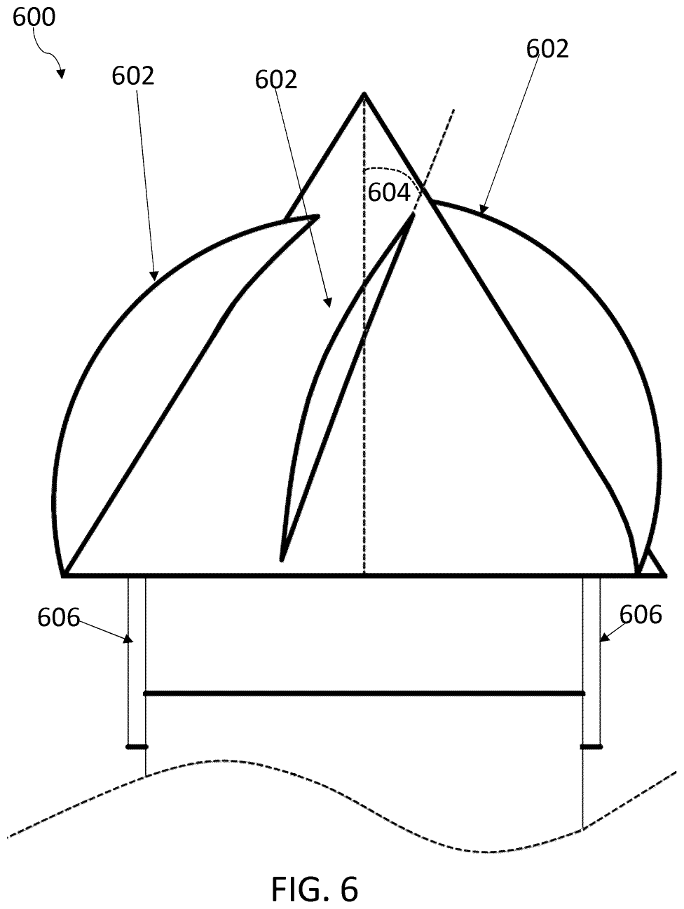

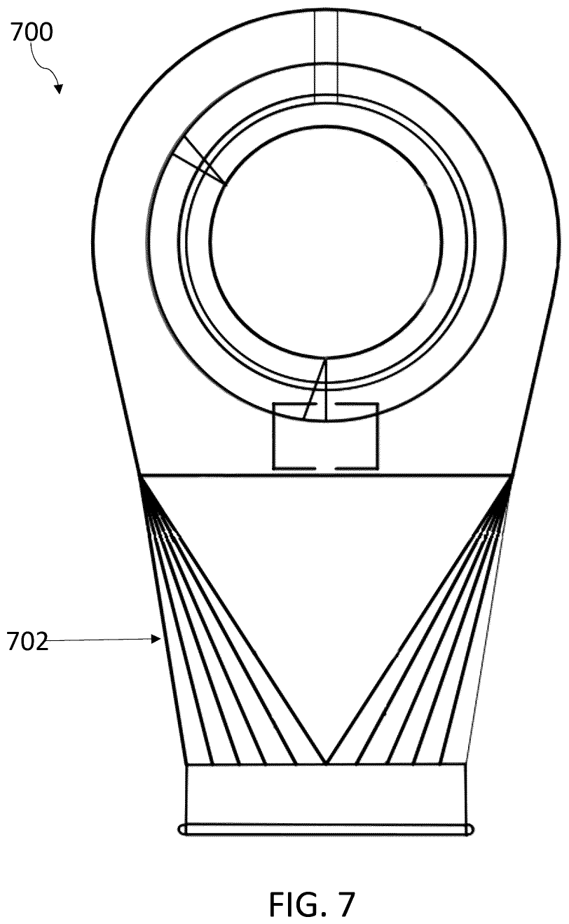

FIG. 6 illustrates an airflow diverter component according to one embodiment of the present invention. The airflow diverter 600 includes a plurality of fins 602. In some embodiments, the airflow diverter component includes a plurality of fins. Each fin of the plurality of fins is at an angled position (e.g., 604) relative to a central line of the airflow diverter component 600. For further example, and without limitation, the plurality of fins is at about a 25-degree angle relative to a central line of the airflow diverter component. In some embodiments, each fin of the plurality of fins is positioned about ninety degrees or a quarter of the circumference of the airflow diverter component. In some embodiments, the airflow diverter component includes carbon steel. In some embodiments, the airflow diverter component includes a plurality of standoffs 606. FIG. 7 illustrates a front view of an in-line separator component including an airflow diverter component with a plurality of fins and a drop out 702. For example, and without limitation, each fin of the plurality of fins is positioned about 120 degrees from another fin relative to the circumference of the airflow diverter component. The plurality of fins includes a quarter round shape.

In some embodiments, an airflow diverter component of an in-line separator (e.g., FIG. 6) includes the following dimensions:

| Diameter of Inlet Cone | Length of Inlet Cone | Thickness of |
|---|---|---|
| (in.) | (in.) | Internal Cone |
| 8 | 5 | 16 Ga. |
| 10 | 9 | 16 Ga. |
| 11 | 9 | 16 Ga. |
| 13 | 10 | 16 Ga. |
| 14 | 12 | 16 Ga. |
| 15 | 12 | 16 Ga. |
| 18 | 15 | 16 Ga. |
| 18 | 15 | 16 Ga. |
| 20 | 15 | 16 Ga. |
| 21 | 17 | 16 Ga. |
| 22 | 18 | 16 Ga. |
| 24 | 20 | 14 Ga. |
| 25 | 21 | 14 Ga. |
| 27 | 21 | 14 Ga. |
| 28 | 21 | 14 Ga. |
| 31 | 25 | 14 Ga. |
| 34 | 28 | 14 Ga. |
| 37 | 31 | 14 Ga. |

Advantageously, the in-line separator is designed to decrease the velocity of inlet airflow to cause dust and other waste materials to fall out of the airflow. This allows the airflow to continue further in an industrial debris filtration and collection system. For example, and without limitation, the in-line separator is operable to reduce the inlet airflow velocity from about 4000 ft/min to about 1300 ft/min. In some embodiments, the in-line separator includes the following characteristics: (1) velocity (feet per minute) of an inlet airflow (V1), (2) a cross-sectional area of an inlet (A1), (3) an airflow velocity in the body portion (V2), (4) a cross-sectional area of a body portion of an in-line separator (A2), (5) a cross-sectional area of an airflow diverter component of an in-line separator (A3), (6) an airflow volume throughout the in-line separator in cubic feet per minute (CFM), (7) a volume of a body portion (V-Body), and (8) a volume of an airflow diverter component (V-Cone). Examples of these characteristics according to various embodiments of an in-line separator are shown below:

| V1 | A1 | V2 | A2 | A3 | CFM | V-Body | V-Cone |
|---|---|---|---|---|---|---|---|
| 4000 | 28.27 | 1300 | 86.998 | 31.10 | 785.398 | 1.0597 | 0.3307 |
| 4000 | 38.48 | 1300 | 118.414 | 42.33 | 1069.014 | 1.6828 | 0.5887 |
| 4000 | 50.27 | 1300 | 154.663 | 55.29 | 1396.263 | 2.5120 | 0.7689 |
| 4000 | 78.54 | 1300 | 241.661 | 86.39 | 2181.662 | 4.9062 | 1.4841 |
| 4000 | 113.10 | 1300 | 347.992 | 124.41 | 3141.593 | 8.4780 | 2.5442 |
| 4000 | 153.94 | 1300 | 473.656 | 169.33 | 4276.057 | 13.4627 | 3.4630 |
| 4000 | 201.06 | 1300 | 618.652 | 221.17 | 5585.054 | 20.0960 | 5.2468 |
| 4000 | 254.47 | 1300 | 782.982 | 279.92 | 7068.583 | 28.6133 | 7.5564 |
| 4000 | 314.16 | 1300 | 966.644 | 345.58 | 8726.646 | 39.2501 | 9.3289 |
| 4000 | 380.13 | 1300 | 1169.639 | 418.15 | 10559.242 | 52.2419 | 12.6563 |
| 4000 | 452.39 | 1300 | 1391.967 | 497.63 | 12566.371 | 67.8242 | 16.6904 |
| 4000 | 530.93 | 1300 | 1633.628 | 584.02 | 14748.032 | 86.2325 | 21.4990 |
| 4000 | 572.56 | 1300 | 1761.708 | 629.81 | 15904.313 | 96.5700 | 23.18466 |

The corresponding structures, materials, acts, and equivalents of all means or step plus function elements in the claims below are intended to include any structure, material, or act for performing the function in combination with other claimed elements as specifically claimed.

Particular embodiments and features have been described with reference to the drawings. It is to be understood that these descriptions are not limited to any single embodiment or any particular set of features, and that similar embodiments and features may arise, or modifications and additions may be made without departing from the scope of these descriptions and the spirit of the appended claims.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. An in-line separator comprising:
an inlet;
an inlet tapered portion;
a tapered airflow diverter component;
a body portion;
an outlet tapered portion; and
an outlet;
wherein the inlet is in fluid connection to the inlet tapered portion;
wherein the body portion in fluid connection to the inlet tapered portion and the outlet tapered portion;
wherein the tapered airflow diverter component is positioned within an interior of the inlet tapered portion, wherein, when air passes through the inlet to the inlet tapered portion, the tapered airflow diverter component diverts the airflow into the body portion; and
wherein, as the airflow passes through the body portion, a velocity of the airflow decreases; and
wherein, after the velocity of the airflow decreases, a plurality of waste materials fall out of the airflow.

2. The in-line separator of claim 1, wherein the in-line separator further includes a drop out, wherein the drop out is connected to a bottom of the body portion.

3. The in-line separator of claim 2, wherein the drop out includes a top end and a bottom end, wherein the top end is connected to the body portion, wherein the bottom end is connected to a storage container.

4. The in-line separator of claim 3, wherein a diameter of the top end of the drop out is larger than a diameter of the bottom end of the drop out.

5. The in-line separator of claim 1, wherein the tapered airflow diverter component does not include vanes.

6. The in-line separator of claim 1, wherein the body portion has a volume about three times larger than a volume of the inlet.

7. The in-line separator of claim 1, wherein a circumference of the inlet tapered portion is equivalent to a circumference of outlet tapered component.

8. The in-line separator of claim 1, further comprising a cleanout window, wherein the cleanout window is positioned on an exterior surface of the body portion, wherein the cleanout window is movable between an open position and a closed position, wherein, when in the open position, the cleanout window provides access to an interior of the body portion.

9. The in-line separator of claim 1, wherein the outlet is connected to the tapered airflow diverter component via a plurality of rod extensions.

10. The in-line separator of claim 1, wherein the tapered airflow diverter component results in airflow passing to a top of an interior of the body portion and a bottom of an interior of the body portion.

11. The in-line separator of claim 10, wherein, after contacting the top of the interior of the body portion and the bottom of the interior of the body portion, airflow is directed to an interior of the tapered airflow diverter component.

12. The in-line separator of claim 1, wherein the inlet is in fluid communication with an upstream dust collector.

13. A debris collection and filtering system comprising:
a debris collector;
an in-line separator;
a negative pressure generation component; and
a container;
wherein the debris collector is operable to collect a plurality of waste materials, wherein the plurality of waste materials include dust;
wherein the negative pressure generation component creates airflow from the debris collector to the in-line separator;
wherein the in-line separator includes an inlet, an inlet portion, a tapered airflow diverter component, a body portion, an outlet portion, an outlet, and a drop out;
wherein the inlet is in fluid connection to the inlet tapered portion and the debris collector;
wherein the body portion is in fluid connection with the inlet portion and the outlet portion;
wherein the tapered airflow diverter component is positioned within an interior of the inlet portion, wherein, when air passes through the inlet to the inlet portion, the airflow diverter component diverts the airflow into the body portion; and
wherein, when the airflow is in the body portion, a velocity of the airflow decreases, the plurality of waste materials fall into the drop out.

14. The debris collection and filtering system of claim 13, wherein the drop out includes a top end and a bottom end, wherein the top end is connected to the body portion, wherein the bottom end is connected to a storage container.

15. The debris collection and filtering system of claim 14, wherein a diameter of the top end of the drop out is larger than a diameter of the bottom end of the drop out.

16. The debris collection and filtering system of claim 13, wherein the tapered airflow diverter component does not include vanes.

17. The debris collection and filtering system of claim 13, when the in-line separator further comprises a cleanout window, wherein the cleanout window is positioned on an exterior surface of the body portion, wherein the cleanout window is movable between an open position and a closed position, wherein, when in the open position, the cleanout window provides access to an interior of the body portion.

18. The debris collection and filtering system of claim 13, wherein a velocity of airflow at the inlet is about 4000 feet per minute, wherein, after traveling through the body portion, a velocity of airflow is about 1300 feet per minute.

19. The debris collection and filtering system of claim 13, wherein the tapered airflow diverter component results in airflow passing to a top of an interior of the body portion and a bottom of an interior of the body portion.

20. The debris collection and filtering system of claim 19, wherein, after contacting the top of the interior of the body portion and the bottom of the interior of the body portion, airflow is directed to an interior of the tapered airflow diverter component.
